(19) United States
(12) Patent Application Publication
(10) Pub. No.: US 2018/0096102 A1
(43) Pub. Date: Apr. 5, 2018

(54) Redaction of Sensitive Patient Data

(71) Applicant: International Business Machines Corporation, Armonk, NY (US)

(72) Inventors: Abimbola Akinmeji, Oakland, CA (US); Corville O. Allen, Morrisville, NC (US); Albert A. Chung, Cary, NC (US); Richard A. Salmon, Apex, NC (US)

(21) Appl. No.: 15/283,477

(22) Filed: Oct. 3, 2016

(51) Int. Cl. G06F 19/00; G06F 21/62; G06F 17/30

(52) U.S. Cl. CPC G06F 19/322; G06F 17/30477; G06F 17/3053; G06F 21/6254

(57) ABSTRACT

Mechanisms are provided to redact sensitive data from a payload. The mechanisms analyze data types in the payload, where the data types correspond to attributes of a person. The mechanisms score the data types as to their sensitivity, which is a measure of a probability that a corresponding data value of the data type, either alone or in combination with other data values, will uniquely identify the person. Each score, or an aggregation of the scores, is compared to a threshold. Responsive to a score, or the aggregation of the scores, being equal to or exceeding the threshold, the mechanisms redact data corresponding to data types whose scores, or the aggregation of scores, are associated. The redacted data is replaced a unique redacted identifier and a data type identifier that identifies at least one data type of the redacted data.

### BACKGROUND

The present application relates generally to an improved data processing apparatus and method and more specifically to mechanisms for providing mechanisms to provide redaction of sensitive patient data, such as for purpose of storage and access via a monitoring or log system.

Decision-support systems exist in many different industries where human experts require assistance in retrieving and analyzing information. An example that will be used throughout this application is a diagnosis system employed in the healthcare industry. Diagnosis systems can be classified into systems that use structured knowledge, systems that use unstructured knowledge, and systems that use clinical decision formulas, rules, trees, or algorithms. The earliest diagnosis systems used structured knowledge or classical, manually constructed knowledge bases. The Internist-I system developed in the 1970s uses disease-finding relations and disease-disease relations. The MYCIN system for diagnosing infectious diseases, also developed in the 1970s, uses structured knowledge in the form of production rules, stating that if certain facts are true, then one can conclude certain other facts with a given certainty factor. DXplain, developed starting in the 1980s, uses structured knowledge similar to that of Internist-I, but adds a hierarchical lexicon of findings.

Iliad, developed starting in the 1990s, adds more sophisticated probabilistic reasoning where each disease has an associated a priori probability of the disease (in the population for which Iliad was designed), and a list of findings along with the fraction of patients with the disease who have the finding (sensitivity), and the fraction of patients without the disease who have the finding (1-specificity).

In 2000, diagnosis systems using unstructured knowledge started to appear. These systems use some structuring of knowledge such as, for example, entities such as findings and disorders being tagged in documents to facilitate retrieval. ISABEL, for example, uses Autonomy information retrieval software and a database of medical textbooks to retrieve appropriate diagnoses given input findings. Autonomy Auminence uses the Autonomy technology to retrieve diagnoses given findings and organizes the diagnoses by body system. First CONSULT allows one to search a large collection of medical books, journals, and guidelines by chief complaints and age group to arrive at possible diagnoses. PEPID DDX is a diagnosis generator based on PEPID's independent clinical content.

Clinical decision rules have been developed for a number of medical disorders, and computer systems have been developed to help practitioners and patients apply these rules. The Acute Cardiac Ischemia Time-Insensitive Predictive Instrument (ACI-TIPI) takes clinical and ECG features as input and produces probability of acute cardiac ischemia as output to assist with triage of patients with chest pain or other symptoms suggestive of acute cardiac ischemia. ACI-TIPI is incorporated into many commercial heart monitors/defibrillators. The CaseWalker system uses a four-item questionnaire to diagnose major depressive disorder. The PKC Advisor provides guidance on 98 patient problems such as abdominal pain and vomiting.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, the at least one memory comprising instructions executed by the at least one processor to cause the at least one processor to redact sensitive data from a payload of data. The method comprises analyzing, by the data processing system, one or more data types of data, in the payload of data, to be written to a first data structure. The one or more data types correspond to attributes of a person. The method further comprises scoring, by the data processing system, the one or more data types as to their sensitivity. The sensitivity of a data type is a measure of a probability that a corresponding data value of the data type, either alone or in combination with other data values associated with other data types, will uniquely identify the person. The method also comprises comparing each score, or an aggregation of the scores of a plurality of data types in the one or more data types, to at least one threshold. Furthermore, the method comprises, responsive to at least one score, or the aggregation of the scores, being equal to or exceeding the at least one threshold, redacting, by the data processing system, data corresponding to one or more data types with which the at least one score, or the aggregation of scores, are associated, from the data structure. In addition, the method comprises replacing, by the data processing system, the redacted data in the data structure with both a unique redacted identifier and at least one data type identifier that identifies at least one data type of the redacted data, to thereby generate a redacted data structure.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of an example data processing system in a computer network in which aspects of the illustrative embodiments may be implemented;

FIG. 2 is a block diagram of an example data processing system in which aspects of the illustrative embodiments are implemented;

FIG. 3 is an example diagram illustrating an interaction of elements of a sensitive patient information engine in accordance with one illustrative embodiment; and

FIG. 4 is a flowchart outlining an example operation of a sensitive information engine in accordance with one illustrative embodiment.

### DETAILED DESCRIPTION

Protecting the privacy of a person's medical information, as may be stored in an electronic medical record (EMR), for example, is of significant importance in any medical system to not only protect the patient but also to avoid liability under governmental law. Various mechanisms have been developed for controlling access to medical information and ensuring privacy of a patient's medical data by implementing access control lists, data anonymization, and the like. Many systems, such as the decision support systems previously discussed above, which analyze or perform operations on patient medical information, use the actual patient data as part of the application processing. This patient data is sensitive and not everyone is approved to view this data. On the other hand, anonymizing this data may make it difficult for these systems to perform their necessary operations correctly.

For example, many times, for development purposes, human computer application developers must work with the actual patient data to further develop or increase the quality of the computer application being developed. In order for these developers to be able to perform their necessary tasks, while maintaining the privacy of the patients whose data is being utilized, the sensitive patient data should be obfuscated. However, this obfuscation should be done in such a way as to permit the development operations to proceed unhindered. In the same way, runtime applications should also be able to operate on patient data that has been obfuscated in an unhindered manner such that they may perform their operations while maintaining the privacy of the patient.

Even in the case of someone being cleared to see patient data through an established agreement, such as in the case of a Health Cloud environment, for example, it is sometimes useful to redact sensitive patient data and thereby remove the patient identifiable data. This is particularly true when providing access to logs of a logging system that maintains sensitive patient information, so as to prevent misuse or inadvertent divulging of this sensitive patient information. The goal is for a developer, engineer, or the like, to be able to look at logs to troubleshoot an application, but maintain the privacy of the patient information.

The illustrative embodiments provide mechanisms to redact, or otherwise obfuscate, sensitive patient data in data structures in order to maintain the privacy of the patient, while replacing that redacted or obfuscated sensitive patient data with information that allows human developers, runtime applications, and the like, to perform their operations unhindered. In particular, the illustrative embodiments provide mechanisms that redact sensitive patient information data and replace the sensitive patient information data with a data type identifier and a redacted identifier. With the mechanisms of the illustrative embodiments, the redacted sensitive patient information data is stored in a redacted patient information database, having limited and controlled access, in association with the redacted identifier such that access may be able to be made to the redacted information if necessary, i.e. the redacted identifier provides a pointer to the redacted sensitive patient information data stored in the secure redacted patient information database. The data type identifier permits the human developer to perform development operations, and the computer application to perform its application operations, unhindered but without exposing sensitive patient data. The sensitive patient information data may then be recovered from the secured redacted patient information database when needed using the redacted identifier.

One of the benefits of the illustrative embodiments is based on HTTP-REST (Representational State Transfer) and Application Program Interfaces (APIs) that are self-describing, in that the parameters or path to the resource can be identified from the call to the API and, through the mechanisms of the illustrative embodiments, deemed sensitive. Such sensitive information may be redacted using the mechanisms of the illustrative embodiments but with sufficient data type information to allow the entry into the system to give provide the data type allowing a basic use of the system.

That is, data processing systems are sometimes made available as a service. In a client/server environment, the client can make a Hypertext Transfer Protocol (HTTP) request to call the server's REST API. The REST API call consists of a Uniform Resource Locator (URL) and parameters. For example, “http://someservice.com/patient?name=john&age=50.” It can be seen from this example that the REST API URL is self-describing with regard to what resource to retrieve, i.e. it is asking for patient information, it is asking for patients that are named John, and it is looking for patients that are 50 years of age. The URL and the parameters (name, age, etc.) gives clues as to the data type and the sensitivity regarding how the REST API call can identify patients.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the present invention provides mechanisms for identifying sensitive patient information in a portion of received data and redacting that information in such a way that the obfuscated data may still be used by human developers and/or applications which must know the data types of the original data. Moreover, the mechanisms further provide for redaction and obfuscation in which redaction identifiers may be used to rebuild the original data with the sensitive patient information. The redacted sensitive patient information is stored in a secured database that has strict access controls such that the redacted sensitive patient information may be retrieved and correlated with the obfuscated information so as to rebuild the originally received data.

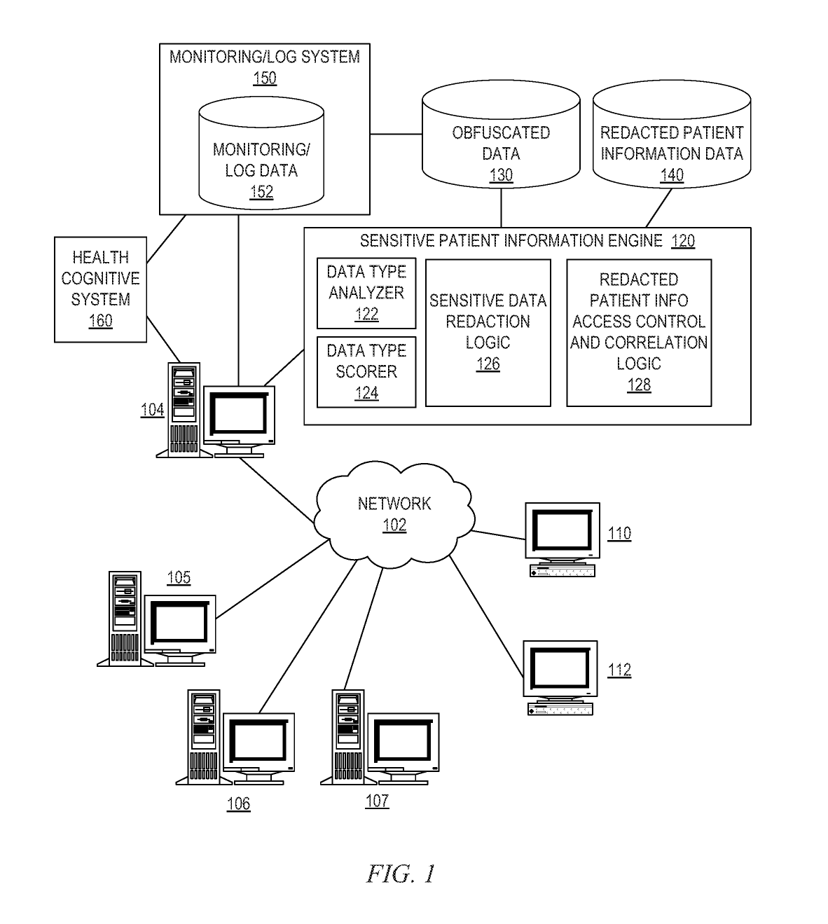

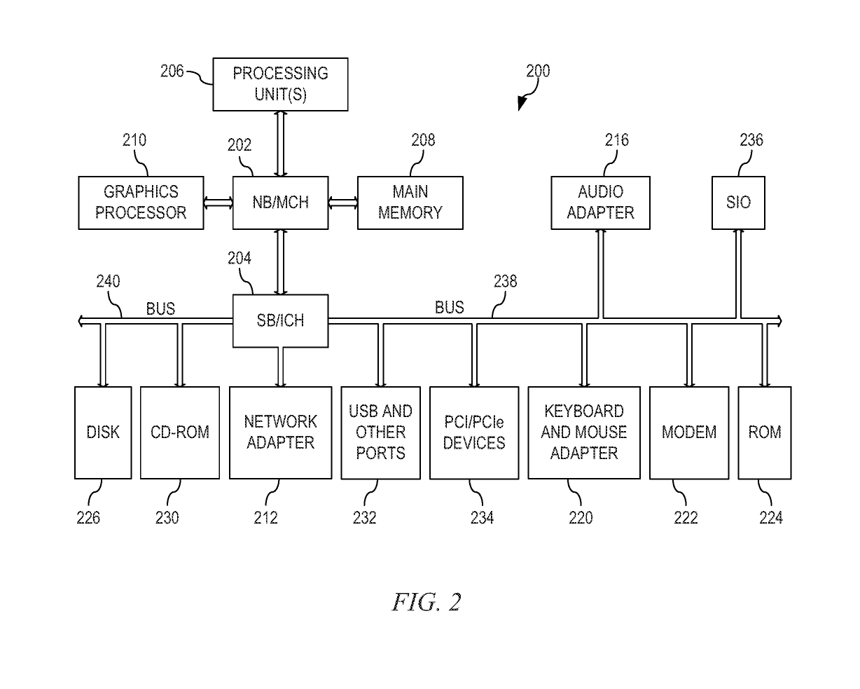

The illustrative embodiments may be utilized in many different types of data processing environments. In order to provide a context for the description of the specific elements and functionality of the illustrative embodiments, FIGS. 1-2 are provided hereafter as example environments in which aspects of the illustrative embodiments may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

In some illustrative embodiments, the mechanisms of the illustrative embodiments operate in conjunction with a patient information monitoring and/or patient information logging system. Such a system is only an example to illustrate a type of system which may handle sensitive patient information that may be used to uniquely identify a patient. The illustrative embodiments may be used with any system in which potentially sensitive patient information may be handled by the system. Such systems may include cognitive systems, such as patient treatment recommendation systems, decision support systems, or the like. The patient information monitoring and/or logging system set forth in the examples is only an example and is not intended to state or imply any limitation with regard to the systems with which the mechanisms of the illustrative embodiments may be utilized.

Moreover, while the illustrative embodiments will be described in the context of redacting sensitive patient information data from payloads being provided to a patient information monitoring and/or logging system, the illustrative embodiments are not limited to operation with sensitive patient information. This is just one example of sensitive information which may need to be redacted from payloads. Any type of sensitive information that is identifiable by a data type and corresponding value may be operated on by the mechanisms of the illustrative embodiments without departing from the spirit and scope of the present invention. Sensitive information is generally classifiable into primary sensitive information, which is information that by itself may be identifiable of a particular individual or entity, and secondary sensitive information, which is information that may identify a particular individual or entity only when combined with other primary or secondary sensitive information. For example, primary sensitive information may include, but is not limited to, names, social security numbers, addresses, and phone numbers. Examples of secondary sensitive information include, but are not limited to, diagnosis, age, ER visit information, race, medications, lab results, physical exam information, vital sign information, family history information, social history information (e.g., smoking, drug use, etc.).

FIG. 1 depicts a schematic diagram of one illustrative embodiment of data processing system in which a data payload being sent to a monitoring/log system is checked for sensitive patient information in accordance with one illustrative embodiment. The monitoring/log system 150 may operate to monitor and/or log patient information from a plurality of different sources, e.g., computing devices 105-107. As such, the monitoring/log system 150 may receive sensitive patient information from these sources which may not be appropriate for viewing by all users or access by all applications. Thus, the illustrative embodiments provide a sensitive patient information engine 120 which operates on such data payloads, such as payloads of data packets being transmitted by the source systems 105-107 to the server 104 hosting the monitoring/log system 150, to redact such sensitive patient information as described in more detail hereafter.

As shown in FIG. 1, the monitoring/log system 150 may operate in conjunction with a healthcare cognitive system 160 to provide data to the healthcare cognitive system 160 and/or users of the healthcare cognitive system 160 such that the data may be viewed and or operated on to perform cognitive operations, such as treatment recommendations, healthcare decision support operations, or the like. Alternatively, the data collected and/or stored by the monitoring/log system 150, such as in monitoring/log database 152, may be provided to a user or other application, on the computing device 104 or other computing device via network 102, for viewing of the data and/or execution of operations on the data in the database 152. For example, a user of a client computing device 110 or 112 may request access to data stored in the monitoring/log database 152, such as for purposes of application development or the like.

As mentioned above, one implementation may provide monitoring/log data for patients from the monitoring/log database 152 to a healthcare cognitive system 160 to perform a healthcare based cognitive operation. In some cases, a developer may be developing algorithms or applications for implementation by the healthcare cognitive system 160 and thus, may need to access monitoring/log data 152 to determine appropriate operation of the algorithms/applications, perform debugging, perform verification, etc. However, the developer, in many cases, should not be provided access to private patient information for particular patients, especially in a form where the developer is able to uniquely identify the patient. Furthermore, the same may be true of particular applications or algorithms implemented by the healthcare cognitive system 160. However, competing with the interest of privacy is the need to be able to perform development operations and/or the algorithm/application operations which may require information that comprises private patient information in order to perform such development operations and/or algorithm/application operations.

In one illustrative embodiment, as depicted, the monitoring/log system 150 provides data from the monitoring/log database 152 to the healthcare cognitive system 160 for performance of its cognitive operations. In some illustrative embodiments, the healthcare cognitive system 160 implements a request processing pipeline, which in some embodiments may be a question answering (QA) pipeline. For purposes of the present description, it will be assumed that the request processing pipeline of the healthcare cognitive system 160 is implemented as a QA pipeline that operates on structured and/or unstructured requests in the form of input questions. One example of a question processing operation which may be used in conjunction with the principles described herein is described in U.S. Patent Application Publication No. 2011/0125734, which is herein incorporated by reference in its entirety. The healthcare cognitive system 160 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104-107 and 110-112 in communication with each other and with other devices or components via one or more wired and/or wireless data communication links, where each communication link comprises one or more of wires, routers, switches, transmitters, receivers, or the like. The healthcare cognitive system 160 and network 102 enables question processing and answer generation (QA) functionality for one or more cognitive system users via their respective computing devices 110-112. Other embodiments of the healthcare cognitive system 160 may be used with components, systems, sub-systems, and/or devices other than those that are depicted herein.

The cognitive system 160 receives input from the network 102, a corpus of electronic documents stored in one or more computing devices or network attached storage systems (not shown), cognitive system users, and/or other data and other possible sources of input. In one embodiment, some or all of the inputs to the healthcare cognitive system 160 are routed through the network 102. The various computing devices 105-107 on the network 102 include access points for content creators and QA system users. Some of the computing devices 105-107 include devices for a database storing the corpus of data. The network 102 includes local network connections and remote connections in various embodiments, such that the healthcare cognitive system 160 may operate in environments of any size, including local and global, e.g., the Internet.

In one embodiment, the content creator creates content in a document of the corpus of data for use as part of a corpus of data with the healthcare cognitive system 160. The document includes any file, text, article, or source of data for use in the healthcare cognitive system 160. QA system users access the cognitive system 160 via a network connection or an Internet connection to the network 102, and input questions to the healthcare cognitive system 160 that are answered by the content in the corpus of data. In one embodiment, the questions are formed using natural language. The healthcare cognitive system 160 parses and interprets the question via a QA pipeline, and provides a response to the cognitive system user, e.g., cognitive system user 110, containing one or more answers to the question. In some embodiments, the healthcare cognitive system 160 provides a response to users in a ranked list of candidate answers while in other illustrative embodiments, the healthcare cognitive system 160 provides a single final answer or a combination of a final answer and ranked listing of other candidate answers.

In some illustrative embodiments, the healthcare cognitive system 160 may be the IBM Watson™ cognitive system available from International Business Machines Corporation of Armonk, N.Y., which is augmented with the mechanisms of the illustrative embodiments described hereafter. As outlined previously, a QA pipeline of the IBM Watson™ cognitive system receives an input question which it then parses to extract the major features of the question, which in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA pipeline of the IBM Watson™ cognitive system then performs deep analysis on the language of the input question and the language used in each of the portions of the corpus of data found during the application of the queries using a variety of reasoning algorithms.

The scores obtained from the various reasoning algorithms are then weighted against a statistical model that summarizes a level of confidence that the QA pipeline of the IBM Watson™ cognitive system has regarding the evidence that the potential response, i.e. candidate answer, is inferred by the question. This process is be repeated for each of the candidate answers to generate ranked listing of candidate answers which may then be presented to the user that submitted the input question, or from which a final answer is selected and presented to the user. More information about the QA pipeline of the IBM Watson™ cognitive system may be obtained, for example, from the IBM Corporation website, IBM Redbooks, and the like. For example, information about the QA pipeline of the IBM Watson™ cognitive system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As noted above, while the input to the healthcare cognitive system 160 from a client device may be posed in the form of a natural language question, the illustrative embodiments are not limited to such. Rather, the input question may in fact be formatted or structured as any suitable type of request which may be parsed and analyzed using structured and/or unstructured input analysis, including but not limited to the natural language parsing and analysis mechanisms of a cognitive system such as IBM Watson™, to determine the basis upon which to perform cognitive analysis and providing a result of the cognitive analysis. In the case of a healthcare based cognitive system, this analysis may involve processing patient medical records, medical guidance documentation from one or more corpora, and the like, to provide a healthcare oriented cognitive system result.

In the context of the present invention, healthcare cognitive system 160 may provide a cognitive functionality for assisting with healthcare based operations. For example, depending upon the particular implementation, the healthcare based operations may comprise patient diagnostics, medical treatment recommendation systems, medical practice management systems, personal patient care plan generation and monitoring, patient electronic medical record (EMR) evaluation for various purposes, such as for identifying patients that are suitable for a medical trial or a particular type of medical treatment, or the like. Thus, the healthcare cognitive system 160 operates in the medical or healthcare type domains and which may process requests for such healthcare operations via the request processing pipeline 108 input as either structured or unstructured requests, natural language input questions, or the like. In one illustrative embodiment, the healthcare cognitive system 160 is a medical treatment recommendation system that analyzes a patient's EMR in relation to medical guidelines and other medical documentation in a corpus or corpora to generate a recommendation as to how to treat a medical condition of a patient.

It can be appreciated that from the nature of a healthcare cognitive system 160, the system 160 operates on a private information about patients, otherwise it could not perform its designed operations. However, during development of the healthcare cognitive system 160, there may be individuals that are involved in the development that should not be given access to private information about patients, even though the algorithms or applications implemented in the healthcare cognitive system 160 operate on such information. Moreover, there are instances where algorithms or applications implemented in a system should not have access to private information about patients.

The illustrative embodiments provide a sensitive patient information engine 120 that provides a mechanism for obfuscating the data that is used to generate the monitoring/log data in the database 152 such that users and/or algorithms/applications accessing the data in the database 152 may be given enough information in the format needed to perform their operations without divulging private patient information. Moreover, the sensitive patient information engine 120, while redacting the private patient information such that it is obfuscated in the resulting data, maintains the private patient information in a secure database with strict access controls such that the original data may be recreated at any time it is needed by authorized users or algorithms/applications. The mechanisms of the sensitive patient information engine 120 may be provided as logic implemented in specialized hardware, software executed on hardware, or any combination of specialized hardware and software executed on hardware.

As shown in FIG. 1, the mechanisms of the sensitive patient information engine 120 include a data type analyzer 122, a data type scorer 124, sensitive data redaction logic 126, and redacted patient information access control and correlation logic 128. The sensitive patient information engine 120 may operate on data being provided to the backend monitoring/log system 150 from one or more source data processing systems via network 102. For example, computing systems, e.g., servers, 105-107 may represent computer systems present at medical service provider locations, e.g., doctor offices, hospitals, medical laboratories, etc., that generate patient information, including sensitive patient data or private patient information, and provide it to the monitoring/log system 150 for collection, such as in the case of a Health Cloud system or the like. The data may be transmitted from these computing systems 105-107 via the network 102 to the data processing system 104 implementing the monitoring/log system 150 and optionally the healthcare cognitive system 160.

The sensitive patient information engine 120 may perform a scrubbing operation on the received data prior to the data being used to generate monitoring/log data in the database 152 that is accessible by users and/or algorithms/applications, which may include users and/or algorithms/applications that should not be provided access to the sensitive patient information present in the originally received data. While not explicitly shown in FIG. 1, it should be appreciated that encryption/decryption mechanisms may be provided such that data transmissions may be encrypted and decrypted so as to maintain privacy of information during transmission. Thus, the data may be decrypted and then scrubbed using the sensitive patient information engine 120, where the scrubbing operation is an operation for identifying the presence of sensitive patient information in the received data, determining if the sensitive patient information should be obfuscated, obfuscating the data and providing the obfuscated data to the monitoring/log system 150 for use in generating monitoring/log data in database 152, and storing the redacted sensitive patient information in a redacted patient information database 140 for later retrieval by authorized individuals.

The elements 122-128 of the sensitive patient information engine 120 work together to redact sensitive patient data (also referred to a private patient information) and replace it with a data type identifier and a redacted identifier while maintaining the redacted sensitive patient data in a data structure that permits access if necessary. Sensitive patient data in this context refers to any patient data or patient information that is uniquely identifiable of the patient and may constitute a single data type, e.g., patient's name, or a combination of data types that together represent uniquely identifiable attributes of the patient, e.g., age, gender, geographical location, disease type, medical trial identifier, etc.

In response to the data processing system 104 receiving a portion of data from a source system 105-107, such as data received from an application program interface (API) or as data packets from the source systems 105-107 and intended to be written to the monitoring/log database 152, the data is initially analyzed by the data type analyzer 122 to determine if the received data comprises any data types that are known to correspond to sensitive patient information. That is, the data type analyzer 122 is configured with configuration data specifying the data types and/or patterns of data types that are recognized as being associated with sensitive patient information. For example, it may be determined that patient name, patient address, phone number, and the like may be sensitive patient information, e.g., primary sensitive information. Alternatively, it may be determined that data types may not in themselves be sensitive but may be sensitive when combined with other data types, such that particular patterns of data types are considered sensitive, e.g., secondary sensitive information. Other data types may not be considered sensitive in any context, such as a date of service or the like.

The data type analyzer 122 extract data types from the received data and compares them to the configuration data specifying the data types, or patterns of data types, that correspond to sensitive patient information. If there are matches, the matching data types and their values in the received data are flagged as potentially being sensitive patient information. This comparison essentially provides an identification of one or more data types corresponding to attributes of the patient that, either alone or in combination, are uniquely identifiable of the patient.

The identified and flagged matching data types in the received data are scored as to their sensitivity by the data type scorer 124. The data type scorer 124 comprises logic and rules for evaluating the data types, the patterns of data types, the aggregates of data types, and the like, to generate a numerical score indicative of the sensitivity of the data present in the received data. The rules and logic may comprise various weighting factors that are applied to different data types based on a previously defined sensitivity of the data types with different weighting factors also being applied when certain combinations of data types are present.

For example, it may be determined that a data type of “Patient Name” is always highly sensitive and this data type will be given a high weighting factor or score indicative of its sensitive nature. On the contrary, a data type of the patient's resident “City” may be given a relatively low weighting factor when it is present by itself in the received data. However, if the patient's resident “City” is present along with the patient's “Diagnosis” then a relatively larger weighting factor and score may be applied to this combination of data types since, while each one individually may not be sensitive, the combination is more likely to identify a narrow population of patients and potentially a single patient. While this combination of data types may be given a relatively larger weighting factor or score, it still may be less than the single data type of “Patient Name.” Thus, various weighting factors and scoring logic may be provided for various data types and/or combinations of data types so as to provide a estimation of the sensitive nature of the data present in a received portion of data based on data types present therein.

The scores generated for the data types and/or combination of data types, or an aggregation of the scores for the data types and/or combination of data types, are compared to at least one threshold by the data type scorer logic 124. If one or more of the scores, or aggregation of the scores, equal or exceed that threshold, meaning that the data types either alone or in combination are likely to be uniquely identifying of the patient, then the patient data corresponding to those data types marked for redaction by the data type scorer logic 124 such that they may be redacted and replaced with data type identifiers and a redacted identifiers by the sensitive data redaction logic 126. In some embodiments, the data types may be ranked based on the scores and only those data types contributing to scores equal to or higher than the threshold are redacted.

The sensitive data redaction logic 126 provides the logic for redacting the data types and values corresponding to the data types marked for redaction by the data type scorer logic 124. In so doing, the sensitive data redaction logic 126 assigns a unique redaction identifier to the particular data type/value being redacted, removes the data type/value information in the received data, and replaces the removed data type/value information in the received data with a data type identifier and the unique redaction identifier to thereby generate obfuscated data 130, i.e. a version of the received data in which sensitive patient information has been obfuscated through redaction and replacement with a data type identifier and redaction identifier.

The data type identifier is included to allow users and/or applications viewing or operating on the obfuscated data 130 that require data type information to perform their operations to be able to have sufficient information to perform such operations without divulging the sensitive patient information. For example, when performing development of algorithms or applications, a human developer often times must verify operation of the algorithms or applications based on data types. Similarly, some algorithmic and application operations require at least the data type to be able to operate properly, e.g., an algorithm looking for a patient name must be able to find the data type “Patient Name” in the input data even though the corresponding value may not be an actual patient's name.

The redacted identifier is provided to provide a mechanism for rebuilding the original received data should access to the original received data be needed. The redacted identifier provides a unique value for mapping the obfuscated data 130 to the redacted patient information which is stored in association with the redacted identifier. That is, the redacted patient data is stored, by the sensitive data redaction logic 126 separately in the redacted patient information database 140 in association with the corresponding redacted identifier. Access to this redacted patient information database 140 is strictly controlled such that only authorized users are able to access this information. An example of the information stored in this redacted patient information database 140 is as follows:
John Jones, PatientName&RedactId341434
Type2Diabetes, Diagnosis&RedactedId249398
Raleigh, City&RedactedId4340
This stored redacted patient information data in the database 140 maps the redaction identifier “RedactId” to a data type and corresponding value present in the originally received data. A similar instance of the RedactId is present in the obfuscated data 130 such as:
PatientName:RedactId341434
Diagnosis:RedactedId249398
City:RedactedId4340
It should be noted that while the RedactId is present in the obfuscated data 130 along with the data type, there is nothing in the obfuscated data 130 itself that is of a sensitive nature or can be used to personally identify a patient.

The obfuscated data 130 is provided to the monitoring/log system 150 which may utilize the received obfuscated data 130 to generate entries in the monitoring/log database 152. It should be appreciated that these entries will not include sensitive patient information since such information has been redacted in the obfuscated data 130 by the sensitive data redaction logic 126. The monitoring/log database 152 may be used to perform developer operations, may be used by algorithms or applications to perform their operations, or the like, without exposing sensitive patient information. For example, as part of a development operation, a human developer may utilize the information in the monitoring/log data structure 152 to troubleshoot issues that may be present in the healthcare cognitive system 160. The concepts, data types, and the like, present in the obfuscated data 130 are available for troubleshooting, however the uniquely identifiable sensitive patient information in the original monitoring/log data received into the server 104 is not available, nor are any uniquely identifiable combinations of such over an aggregate of the monitoring/log data. This allows the user to identify errors or issues that are not data related but are system or program related. However, in cases where the errors or issues are determined to be data related, authorized individuals are able to cross-reference the redacted identifiers in the monitoring/log database 152 with the redacted patient information data stored in the redacted patient information database 140 to again access the sensitive patient information when necessary.

In order to identify the patient for which the original data was sent to the server 104, one must have access to the redacted patient information data in the database 140, whose access is strictly controlled by the redacted patient information access control and correlation logic 128. In response to a request to access the original received data, or to perform an operation that requires sensitive patient information, the redacted patient information access control and correlation logic 128 performs operations to control access to only those individuals, applications, and the like, that have been given permissions to access the sensitive patient information which is present in the redacted patient information database 140. The redacted patient information access control and correlation logic 128 may utilize any known, or later developed, access control mechanisms, such as access control lists (ACLs), white lists, black lists, authentication mechanisms such as login/password verification, or the like.

Moreover, the redacted patient information access control and correlation logic 128 provides logic for correlating the redacted patient information data from database 140 with data stored in monitoring/log database 152 based on the obfuscated data 130. That is, the entries in the monitoring/log database 152 generated based on obfuscated data 130 will include the data type identifiers and redaction identifiers included in the obfuscated data 130. The redaction identifiers in these entries may be correlated with the same redaction identifiers in entries of the redacted patient information database 140 to identify correlated entries. The data type identifiers may then be used to map the data type in the entry of the monitoring/log database 152 to the corresponding data type and value present in the entry in the redacted patient information database 140 such that the data type identifier in the monitoring/log database 152 entry may be mapped to the data type and value in the redacted patient information. In this way, for authorized users/applications, access to the redacted patient information may be provided and the originally received data rebuilt when needed.

A method to implement the mechanisms of one or more of the illustrative embodiments may be utilized as part of a parser, such as within an Elastic Search, Logstash, Kibana (ELK) Stack, or the like. Either in the Elastic Search or in the Logstash extension, for example, a plugin may be implemented that does the analysis of data type and performs introspection or cross reference from the API documentation to determine the possible fields and positions. As part of the extension, the redacted identifier of the illustrative embodiments may be attached.

Thus, the illustrative embodiments provide mechanisms for protecting sensitive patient information while providing sufficient information in monitoring/log data to allow human developers, algorithms, applications, and the like, to perform their operations. The illustrative embodiments determine whether sensitive patient information is present in received data and, if so, redact such sensitive patient information and replace it with data type identifiers and a redaction identifier such that the data type identifier may be used by the human developers, algorithms, or applications without divulging sensitive patient information. Moreover, the redaction identifier may be used to correlate the obfuscated data with the sensitive patient information that was redacted.

It should be appreciated that while the above illustrative embodiments are described in the context of sensitive patient information, the same mechanisms may be used with any type of sensitive information that may be received by the server 104. Thus, for example, in a financial domain, employer/employee domain, national security domain, or the like, similar mechanisms may be used to redact sensitive information from received data to ensure that unauthorized persons, algorithms, or applications may use an obfuscated form of the received data to perform their operations without divulging the sensitive information. Thus, the illustrative embodiments are not limited to sensitive patient information and this is given in the above description only as an example implementation.

It is clear from the above that the mechanisms of the illustrative embodiments are rooted in the computer technology arts and are implemented using logic present in such computing or data processing systems to solve the problem of access to sensitive patient information by unauthorized users or applications. These computing or data processing systems are specifically configured, either through hardware, software, or a combination of hardware and software, to implement the various operations described above. As such, FIG. 2 is provided as an example of one type of data processing system in which aspects of the present invention may be implemented. Many other types of data processing systems may be likewise configured to specifically implement the mechanisms of the illustrative embodiments.

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a cognitive system 100 and QA system pipeline 108 augmented to include the additional mechanisms of the illustrative embodiments described hereafter.

In the depicted example, data processing system 200 employs a hub architecture including North Bridge and Memory Controller Hub (NB/MCH) 202 and South Bridge and Input/Output (I/O) Controller Hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCl/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 10°. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive) (AIX® operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224; , or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, smart telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

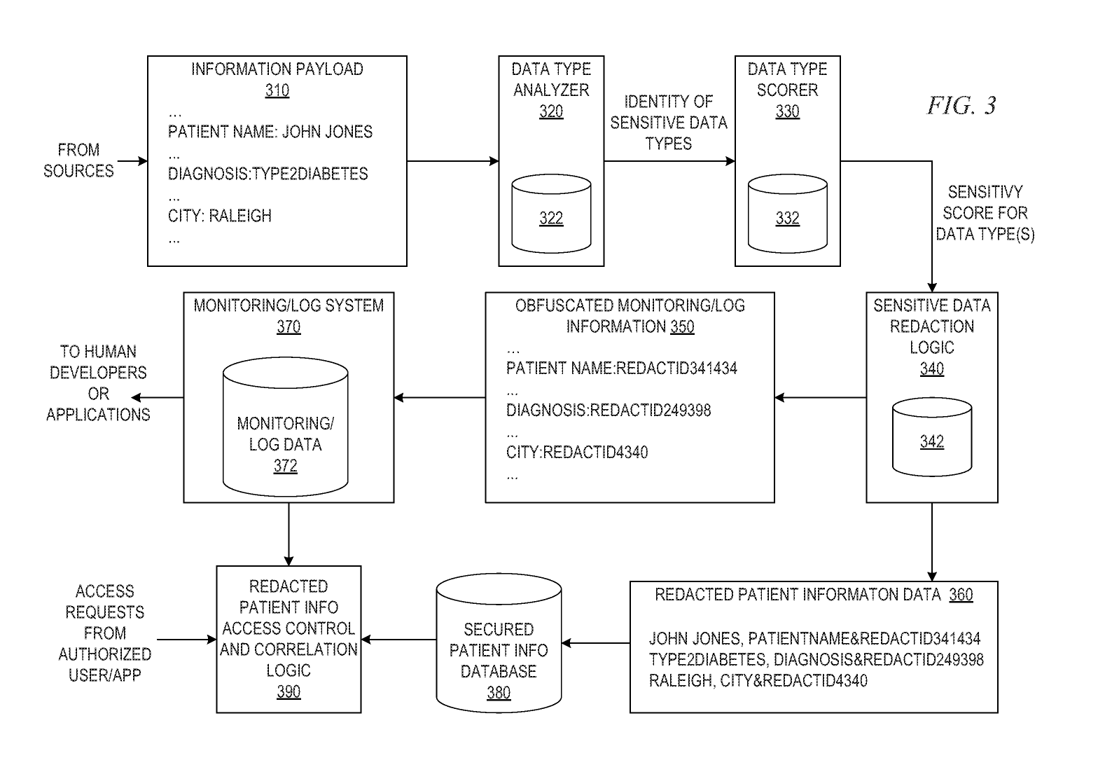

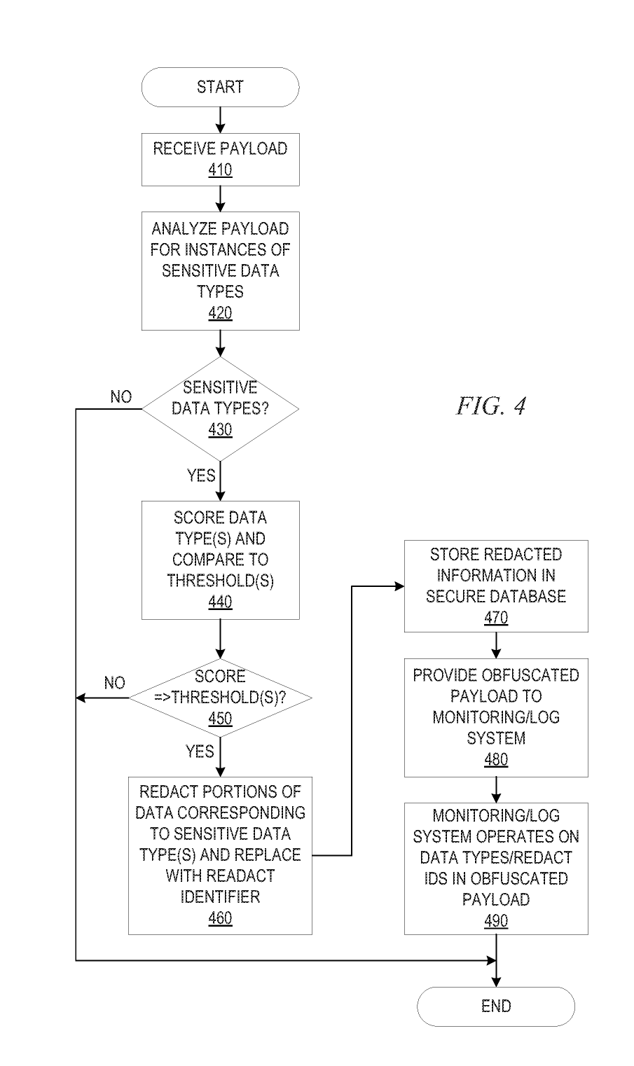

FIG. 3 is an example diagram illustrating an interaction of elements of a sensitive patient information engine in accordance with one illustrative embodiment. Again, while FIG. 3, and FIG. 4 hereafter, use sensitive patient information as an example of the type of sensitive information being protected by the mechanisms of the illustrative embodiments, the illustrative embodiments are not limited to such and any sensitive information may be redacted using the mechanisms of the illustrative embodiments, depending on the implementation domain, without departing from the spirit and scope of the present invention.

As shown in FIG. 3, an information payload 310 may be received from a source system for use by the monitoring/log system 370 to generate a monitoring/log entry in the monitoring/log database 372. The information payload 310 may have sensitive patient information that may be used to personally identify the patient. For example, in the depiction of FIG. 3, the information payload 310 includes, among other information, the patient's name, the patient's diagnosis, and the patient's resident city which can be used individually or in combination to uniquely identify the patient. This information may be received in an encrypted format from a source system and decrypted at the sensitive patient information engine for processing and redaction in accordance with the illustrative embodiments.

For example, a patient may be admitted into the hospital and, as a part of the admittance procedure, as well as treatment of the patient, certain electronic medical records (EMRs) may be generated comprising patient information, which is then sent to the monitoring log system 370 for storage as monitoring/log entry data structures in the database 372. Meanwhile, some algorithms/applications may operate on the monitoring/log data structures in the database 372 but, due to security concerns, may not have authorization to access sensitive patient information. Alternatively, a human developer may be working on developing an algorithm/application, solving technical issues present in a system that utilizes the data from the database 372, or the like, and thus, may need to have access to data in the monitoring/log database 372 but should not be given access to sensitive patient information.

The sensitive patient information engine of the illustrative embodiments may be employed to scrub the information payload 310 of any sensitive patient information prior to storage of the information payload 310 in the monitoring/log database 372. In particular, the data type analyzer 320 comprises configuration data 322 that identifies data types that have been determined to be likely associated with sensitive patient information. The data type analyzer 320 searches the information payload 310 for data types matching the data types present in the configuration data 322 and flags those instances of matching data types in the information payload 310 for further processing by data type scorer 330. The data type scorer 330 has configuration data 332 which indicates the rules and logic to be applied to different data types, patterns of data types, and combinations of data types, to generate a sensitivity score for the flagged sensitive data type instances in the information payload. The sensitivity scores for the data type instances, combinations and patterns of data type instances, and the like, may be compared to one or more threshold sensitivity values to determine whether the sensitivity of the patient information in the information payload 310 is such that redaction is warranted. For example, if the sensitivity score for a data type, pattern or data types, or aggregate combination of data types, is equal to or greater than a threshold value, then the data type(s) are too sensitive for storage in the monitoring/log data structure 372 and should be redacted.

The evaluation of the sensitivity scores may be done at various levels of granularity, such as on an individual data type basis, a pattern of a predetermined number of data types, or an aggregate of all of the data types present in the information payload that have been flagged as potentially associated with sensitive patient information. Thus, the same data type may be associated with multiple sensitivity scores so as to evaluate the data types based on their ability to uniquely identify a patient by themselves as well as in combination with other data types. If a pattern of data types or aggregate combination of data types has a sensitivity score that indicates the pattern or aggregate to be too sensitive and warrants redaction, then all of the individual data type instances in the information payload 310 that contribute to that pattern or aggregate combination may be marked for redaction by the data type scorer 330.

Based on the evaluation of sensitivity scores by the data type scorer 330, data type instances in the information payload 310 are marked for redaction if they are determined to be too sensitive, e.g., meet or exceed a threshold sensitivity value, and should be redacted. The sensitive data redaction logic 340 comprises configure data 342 that indicates the data type identifiers to use with the marked data types as well as provides logic for generating unique redaction identifiers for data values corresponding to data type instances that are marked for redaction. The sensitive data redaction logic 340 removes the marked data types and corresponding values from the information payload 310 and replaces them with a data type identifier and redaction identifier to generate obfuscated payload 350. As shown in FIG. 3, the obfuscated payload 350 does not include the sensitive patient information of the patient's actual name, diagnosis, or resident city and instead has replaced that sensitive patient information with a redaction identifier.

The obfuscated payload 350 is provided to the monitoring/log system 370 for use in generating entries in the monitoring/log database 372. This information stored in the monitoring/log database 372 may be accessed by human developers, algorithms, and applications to perform operations without divulging the sensitive patient information since the entries in the database 372 do not include the sensitive patient information due to the operation of the mechanism of the illustrative embodiments. However, the entries in the database 372 contain sufficient information for the human developer, algorithms, or applications to operate on data types and thus, can perform their operations without accessing sensitive patient information.

In addition to generating the obfuscated payload 350, the sensitive data redaction logic 340 stored the redacted patient information data 360 redacted from the information payload 310 in association with the redaction identifiers in the secured patient information database 380. As shown in FIG. 3, the redacted patient information data 360 comprises the sensitive patient information associated with a data type and unique redaction identifier. The secured patient information database 380 is subject to strict access controls such that the human developers, algorithms, and applications that access the data in the monitoring/log database 372 may not have access to the sensitive patient information stored in the secured patient information database 380. Only authorized individuals, algorithms, and applications may access this secured patient information via the database 380 using access control mechanisms implemented via redacted patient information access control and correlation logic 390. This logic 390 further provides mechanisms for correlating entries in the database 380 with entries in database 372 so as to rebuild the information payload 310 based on correlation of redaction identifiers and data type identifiers.

FIG. 4 is a flowchart outlining an example operation of a sensitive information engine, such as sensitive patient information engine 120 in FIG. 1, in accordance with one illustrative embodiment. As shown in FIG. 4, the operation starts with receiving a payload (step 410). The payload is analyzed to determine if it includes instances of sensitive data types (step 420). A determination is made as to whether the payload includes sensitive data types (step 430) and if not, the operation terminates with regard to this received payload. Otherwise, if sensitive data types are present, then the data types, aggregates of data types, patterns of data types, and the like, may be scored to generate sensitivity scores which are compared to one or more sensitivity threshold values (step 440).

A determination is made as to whether one or more of the sensitive scores equal or exceed a threshold sensitivity value (step 450). If not, the operation terminates with regard to this received payload. If the sensitivity score for a data type, pattern of data types, or aggregate combination of data types meets or exceeds the threshold sensitivity value, then portions of data corresponding to the sensitive data type(s) whose sensitivity score meets or exceeds the threshold sensitivity value are redacted and replaced with a redaction identifier (step 460). The redacted portion of data, i.e. the sensitive information in the payload, is stored in a secured database in association with the redaction identifier (step 470). The obfuscated payload having the replaced portion of data is provided to the backend monitoring/log system (step 480) which then operates on the data types and redaction identifiers in the obfuscated payload (step 490) and the operation terminates.

Thus, the illustrative embodiments provide mechanisms for protecting sensitive information in received payloads by identifying instances of data types that correspond to sensitive information and redacting this information. The redaction is done in such a way as to replace the sensitive information with data type identifiers that can be used by human developers, algorithms, and applications that utilize data types as a way to perform their operations. The redaction is also done so as to replace the sensitive information with a redaction identifier that can be used by authorized individuals, algorithms, and/or applications to rebuild the originally received payload with the sensitive information should the need arise.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions executed by the at least one processor to cause the at least one processor to redact sensitive data from a payload of data, the method comprising:
analyzing, by the data processing system, one or more data types of data, in the payload of data, to be written to a first data structure, wherein the one or more data types correspond to attributes of a person;
scoring, by the data processing system, the one or more data types as to their sensitivity, wherein the sensitivity of a data type is a measure of a probability that a corresponding data value of the data type, either alone or in combination with other data values associated with other data types, will uniquely identify the person;
comparing, by the data processing system, each score, or an aggregation of the scores of a plurality of data types in the one or more data types, to at least one threshold;
responsive to at least one score, or the aggregation of the scores, being equal to or exceeding the at least one threshold, redacting, by the data processing system, data corresponding to one or more data types with which the at least one score, or the aggregation of scores, are associated, from the data structure; and
replacing, by the data processing system, the redacted data in the data structure with both a unique redacted identifier and at least one data type identifier that identifies at least one data type of the redacted data, to thereby generate a redacted data structure.

2. The method of claim 1, further comprising:
providing, by the data processing system, the redacted data structure to another computing system that performs operations on the redacted data structure without exposing data values that uniquely identify the person.

3. The method of claim 2, wherein the operation performed by the other computing system is one of an application development operation for developing an application or a debugging operation for debugging an application that operates on the data stored in the first data structure.

4. The method of claim 1, wherein only data in the payload associated with data types whose scores are equal to or greater than the at least one threshold are redacted in the redacted data structure and other data in the payload associated with other data types are not redacted in the redacted data structure.

5. The method of claim 1, further comprising:
storing the redacted data, separate from the redacted data structure, in a redacted data storage in association with the corresponding redacted identifier.

6. The method of claim 5, wherein access to the redacted data storage is strictly controlled through an access control mechanism such that only authorized users or applications are able to access information in the redacted data storage.

7. The method of claim 5, further comprising:
in response to a request to recreate the payload, performing a lookup operation, in the redacted data storage, of the redacted identifier present in the redacted data structure;
retrieving, from the redacted data storage, the redacted data corresponding to the redacted identifier; and
recreating the payload by replacing the redacted identifier in the redacted data structure with the redacted data retrieved from the redacted data storage.

8. The method of claim 1, wherein the person is a patient, the payload of data provides patient data, and wherein the one or more data types comprise data types of patient data that have a probability of uniquely identifying the patient.

9. The method of claim 1, wherein scoring the one or more data types as to their sensitivity, comprising providing higher scores to data types corresponding to primary sensitive information than data types corresponding to secondary sensitive information, wherein primary sensitive information is information that by itself is uniquely identifiable of the person, and wherein secondary sensitive information is information that is uniquely identifiable of the person only when viewed in combination with other primary or secondary sensitive information.

10. The method of claim 1, further comprising:
providing, by the data processing system, the redacted data structure to another cognitive decision support system to perform operations for generating a decision support output; and
performing, in an application development environment of a computing system, an application development operation for developing an application of the cognitive decision support system based on processing of the redacted data structure by the cognitive decision support system, without exposing data values that uniquely identify the person to the application development environment.

11. A computer program product comprising a computer readable storage medium having a computer readable program stored therein, wherein the computer readable program, when executed on a computing device, causes the computing device to:
analyze one or more data types of data, in a payload of data, to be written to a first data structure, wherein the one or more data types correspond to attributes of a person;
score the one or more data types as to their sensitivity, wherein the sensitivity of a data type is a measure of a probability that a corresponding data value of the data type, either alone or in combination with other data values associated with other data types, will uniquely identify the person;
compare each score, or an aggregation of the scores of a plurality of data types in the one or more data types, to at least one threshold;
responsive to at least one score, or the aggregation of the scores, being equal to or exceeding the at least one threshold, redact data corresponding to one or more data types with which the at least one score, or the aggregation of scores, are associated, from the data structure; and
replace the redacted data in the data structure with both a unique redacted identifier and at least one data type identifier that identifies at least one data type of the redacted data, to thereby generate a redacted data structure.

12. The computer program product of claim 11, wherein the computer readable program further causes the computing device to:
provide the redacted data structure to another computing system that performs operations on the redacted data structure without exposing data values that uniquely identify the person.

13. The computer program product of claim 11, wherein only data in the payload associated with data types whose scores are equal to or greater than the at least one threshold are redacted in the redacted data structure and other data in the payload associated with other data types are not redacted in the redacted data structure.

14. The computer program product of claim 11, wherein the computer readable program further causes the computing device to store the redacted data, separately from the redacted data structure, in a redacted data storage in association with the corresponding redacted identifier.

15. The computer program product of claim 14, wherein access to the redacted data storage is strictly controlled through an access control mechanism such that only authorized users or applications are able to access information in the redacted data storage.

16. The computer program product of claim 14, wherein the computer readable program further causes the computing device to:
in response to a request to recreate the payload, perform a lookup operation, in the redacted data storage, of the redacted identifier present in the redacted data structure;
retrieve, from the redacted data storage, the redacted data corresponding to the redacted identifier; and
recreate the payload by replacing the redacted identifier in the redacted data structure with the redacted data retrieved from the redacted data storage.

17. The computer program product of claim 11, wherein the person is a patient, the payload of data provides patient data, and wherein the one or more data types comprise data types of patient data that have a probability of uniquely identifying the patient.

18. The computer program product of claim 11, wherein scoring the one or more data types as to their sensitivity, comprising providing higher scores to data types corresponding to primary sensitive information than data types corresponding to secondary sensitive information, wherein primary sensitive information is information that by itself is uniquely identifiable of the person, and wherein secondary sensitive information is information that is uniquely identifiable of the person only when viewed in combination with other primary or secondary sensitive information.

19. The computer program product of claim 11, wherein the computer readable program further causes the computing device to:
provide the redacted data structure to another cognitive decision support system to perform operations for generating a decision support output; and
perform, in an application development environment, an application development operation for developing an application of the cognitive decision support system based on processing of the redacted data structure by the cognitive decision support system, without exposing data values that uniquely identify the person to the application development environment.

20. An apparatus comprising:
a processor; and
a memory coupled to the processor, wherein the memory comprises instructions which, when executed by the processor, cause the processor to:
analyze one or more data types of data, in a payload of data, to be written to a first data structure, wherein the one or more data types correspond to attributes of a person;
score the one or more data types as to their sensitivity, wherein the sensitivity of a data type is a measure of a probability that a corresponding data value of the data type, either alone or in combination with other data values associated with other data types, will uniquely identify the person;
compare each score, or an aggregation of the scores of a plurality of data types in the one or more data types, to at least one threshold;
responsive to at least one score, or the aggregation of the scores, being equal to or exceeding the at least one threshold, redact data corresponding to one or more data types with which the at least one score, or the aggregation of scores, are associated, from the data structure; and
replace the redacted data in the data structure with both a unique redacted identifier and at least one data type identifier that identifies at least one data type of the redacted data, to thereby generate a redacted data structure.
